(19) United States
(12) Patent Application Publication
(10) Pub. No.: US 2008/0277610 A1
(43) Pub. Date: Nov. 13, 2008

(54) PUSH FIT COUPLING AND PIPE CONNECTION FOR A PUSH FIT COUPLING

(75) Inventors: Frank BAHNER, Offenbach/Main (DE); Bruno Jacksteit, Nidderau (DE); Matthias Bahlke, Gelnhausen (DE); Oliver Strauss, Nidderau (DE); Dirk Kramer, Noerten-Hardenberg (DE); Hermann Cichorek, Giebolderhausen (DE); Siegfried Kurt Baier, Hockenheim (DE)

Correspondence Address: GREENBLUM & BERNSTEIN, P.L.C., 1950 ROLAND CLARKE PLACE, RESTON, VA, 20191, US

(73) Assignees: NORMA Germany GmbH, Maintal (DE); CARENG automotive GmbH, Langenberg (DE)

(21) Appl. No.: 12/115,893

(22) Filed: May 6, 2008

(30) Foreign Application Priority Data
May 10, 2007 (DE) 10 2007 021 853.4

(51) Int. Cl. F16L 37/12; F16L 37/28

(52) U.S. Cl. 251/148; 285/308; 285/330; 251/149

(57) ABSTRACT

Push fit coupling and method for connecting two fluid lines. The coupling includes a first element having a plug-in opening, a second element insertable into the plug-in opening, a retaining device for detachably holding the first and second elements together, and a valve, insertable into the plug-in opening, located on a front face of the second element.

### CROSS-REFERENCE TO RELATED APPLICATIONS

The present application claims priority under 35 U.S.C. § 119(a) of German Patent Application No. 10 2007 021 853.4 filed May 10, 2007, the disclosure of which is expressly incorporated by reference herein in its entirety.

### BACKGROUND OF THE INVENTION

1. Field of the Invention

The invention relates to a push fit coupling for connecting two fluid lines, having a first element, which has a plug-in opening, a second element, which can be inserted into the plug-in opening, and a retaining device for holding the two elements together in a detachable manner.

2. Discussion of Background Information

A push fit coupling of this type is known, e.g., from DE 37 27 858 C2. The retaining device thereby has two latching elements, which are connected to the second element via arms. The first element has a projection, behind which the latching elements can snap in. The two arms are connected to one another by a ring. When this ring is squeezed, the arms are bent apart, so that the second element can be detached from the first element.

A push fit coupling of this type can be used for many purposes. As the fluids, liquids or gases can be conducted through a line branch that is provided with the push fit coupling. In some cases, it is desirable to be able to influence the flow of the fluid in the push fit coupling.

### SUMMARY OF THE INVENTION

The invention influences a flow through the push fit coupling.

According to the invention, a push fit coupling of the type generally described above can include a valve arranged on a front face of the second element inserted into the plug-in opening.

The flow of the fluid through the push fit coupling can be influenced with the valve. The arrangement of the valve on the front face of the second element has two advantages. The valve is arranged at one end of a line section, which ends in the second element. With a disconnected push fit coupling, the valve can be used, e.g., to close the line branch that leads up to the second element. The arrangement of the valve on the front face has the further advantage that a large part of the installation space required for the valve can be arranged outside the free cross section of the line, so that the line cross section in the region of the push fit coupling is reduced only to an acceptable extent.

The valve can preferably include a valve element and a body that is welded to the second part. When the body of the valve is welded to the second element, virtually no additional installation space is needed to produce the connection between the body and the second element. In this manner, the size of the combination of valve and second element can be kept small. The second element with a valve can be kept virtually the same size or only negligibly larger than a second element of a push fit coupling without a valve. Furthermore, a seal tightness can be produced at the same time with the aid of a welded joint so that no additional measures need to be taken to seal the valve with respect to the second element.

Preferably, the body can have at least two torque working surfaces. The torque working surfaces allow a tool to act on the body and to rotate it. When this is possible, the welding of the body to the second element can be carried out by a friction welding. This makes the production of a combination of second element and valve relatively easy, because no further tools need to be guided to the weld seam from the outside. In particular, when the body as well as the second element is made of a plastic, the heat that can be produced by friction is sufficient to produce the temperature necessary for welding.

Preferably, the second element may have a diameter enlargement in the region of the front face. The diameter enlargement can create space to accommodate at least part of the body. The size of the combination of valve and second element can thus be kept small.

It may be particularly preferred for the second element to have a reduced wall thickness in the region of the diameter enlargement. Since the valve, to be more exact the valve body, increases the load-bearing capacity of the second element in the region of the front face, this load-bearing capacity no longer needs to be ensured through a correspondingly large wall thickness; instead the wall thickness can be reduced, so that a part of the body can also be accommodated outside a wall that surrounds the channel guided through the second element, without enlarging the outside diameter of the second element here.

Preferably, the body can have a peripheral groove into which the front face of the second element snaps. The body encompasses a cylinder wall of the second element through which a channel runs, i.e., radially, from the inside and from the outside. This leads to an increased mechanical stability.

Preferably, the valve element may be connected to the body via a slip joint. A slip joint can be easily released. The valve element can therefore be easily replaced if is worn or shows damage after a certain operating period.

It may be particularly preferred for the valve element to be embodied as a valve plate. A flow check valve, for example, can be simply realized with a valve plate. The valve plate has a certain resilience and deformability, so that the flow of a fluid from one direction can lift the valve element from a valve seat while deforming the valve plate, but in the other flow direction the valve element presses against the valve seat.

Preferably, the body can have a retaining cam onto which the valve plate is fitted. Expediently, the retaining cam may have a peripheral projection, to be overcome when fitting on the valve plate, in order to snap the valve plate into the retaining cam.

In an alternative embodiment, it may be provided for the valve plate to have a securing pin that is inserted into the body. The valve element can be embodied in a mushroom-like manner, such that the foot of the mushroom is formed by the securing pin. It may also be expedient to embody the securing pin with a thickening, with the aid of which it can be snapped into the body.

Preferably, the valve plate can bear prestressed against a valve seat embodied on the body. This can provide the advantage that the valve can seal tightly whenever it is not acted on by a flow or a pressure difference.

Preferably, a hold-down device for the valve element may be snapped into the body. The hold-down device can prevent the valve element from moving too far from the valve seat when it releases the flow through the second element. When the hold-down device can be snapped into the body, which provides an advantage of easy assembly. Further, the hold-down device can be simply pressed onto the body after the valve element has been attached. In the event of a fault, it is possible to easily detach the hold-down device from the body in order to be able to replace the valve element.

It may be preferred for the hold-down device to have several arms arranged in a star-like manner and for the body to have projections that are arranged between the webs. Between the projections and the webs, a free space can remains in which a tool can engage in order to rotate the body with respect to the second element. In this way, the friction-welding connection can be produced. The valve with valve element and hold-down device can then be preassembled, and the preassembled valve can then be welded to the second element.

The invention also relates to a pipe connection for a push fit coupling, which is embodied as a second element of the push fit coupling described above.

The invention is directed to a push fit coupling for connecting two fluid lines. The coupling includes a first element having a plug-in opening, a second element insertable into the plug-in opening, a retaining device for detachably holding the first and second elements together, and a valve, insertable into the plug-in opening, located on a front face of the second element.

According to a feature of the invention, the valve can include a valve element and a body fixedly connected to the second element. Further, the body may be welded to the second element. The body may further include at least two torque working surfaces.

Also, the second element can have a diameter enlargement in a region of the front face, and the second element may have a reduced wall thickness in a region of the diameter enlargement.

In accordance with another feature of the instant invention, the body may have a peripheral groove into which the front face of the second element is connectable, and the front face can be connectable to the peripheral groove through a snap connection. The valve element may be connected to the body via a slip joint. Further, the valve element can include a valve plate. The body may include a retaining cam onto which the valve plate is fitted and/or the valve plate can have a securing pin insertable into the body and/or the valve plate may be prestressed against a valve seat, which can be formed on the body.

According to another feature, a hold-down device for the valve element may be snapped into the body. The hold-down device can include several arms arranged in a star-like manner and the body includes has projections arranged between the arms.

In accordance with still another feature of the invention, the second element is formed by a pipe, whereby the push fit coupling forms a pipe connection.

The invention is directed to a method for connecting two elements. The method includes positioning a valve on a front face of an element, inserting the front face of the element into a plug-in opening of another element, and detachably coupling the element and the another element together.

In accordance with a feature of the invention, the element and the another element may include fluid lines to be connected.

In accordance with still yet another feature of the present invention, the method can further include restricting a flow of fluid directed toward the valve.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a first embodiment of a push fit coupling according to the invention;

FIG. 2 illustrates an enlarged representation of a valve;

FIG. 3 illustrates a perspective view of the valve depicted in FIG. 2; and

FIG. 4 illustrates a second embodiment of a push fit coupling according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A push fit coupling 1 has a first element 2 and a second element 3. Both elements 2, 3 can be connected to fluid lines in a manner not shown in further detail. A fluid line can also be formed by a container for the purposes of the present description.

First element 2 has a plug-in opening 4, into which second element 3 is inserted. First element 2 has a peripheral projection 5, which forms part of a retaining device. A latch (not shown) can snap in behind the projection 5. Moreover, this latch can be connected to second element 3. For further details see DE 37 27 858 C2.

Two sealing rings 6, 7 provide a fluid-tight connection between the two elements 2, 3.

Second element 3 includes a valve 9 on its front face 8. Valve 9 has a body 10, a valve element 11 and a hold-down device 12. Valve element 11 bears against a valve seat 13 with a certain prestressing, and valve seat 13 is embodied or formed on the body 10.

On its end facing second element 3, the body 10 has a peripheral groove 14, which encompasses a cylinder wall 15 radially inside and radially outside. Cylinder wall 15 forms the front-face end of second element 3. It has a smaller wall thickness compared to the other end of second element 3. Furthermore, it surrounds a diameter enlargement 16 of a channel 17 running through second element 3, and a part 18 of body 10 of valve 9 projects into enlargement 16.

On its end facing away from second element 3, body 10 has several projections 19 that form torque working surfaces. A tool (not shown in further detail) can act on projections 19 in order to rotate body 10 with respect to second element 3, when body 10 bears against second element 3. Body 10, as well as second valve element 3, can be made of a plastic. Further, frictional heat can be generated through the rotation of parts 2 and 3 relative to one another, and this frictional heat in turn can produce a temperature that is sufficient to connect body 10 to second element 3 by friction welding.

Body 10 of valve 9 has a wall 21 positionable to cover channel 17 and includes several openings 22 to allow fluid to pass through channel 17 when valve element 11 is lifted from valve seat 13. A lifting of this type is rendered possible, e.g., by fluid flowing through channel 17 and acting on valve element 11 from the valve seat side. However, if a lower pressure prevails in channel 17 than outside, valve element 11 is pressed on valve seat 13, whereby valve 9, which is embodied as a flow check valve, remains closed.

Valve element 11 can be embodied or formed as a valve plate to be pushed onto a retaining cam 23. Retaining cam 23 is connected in one piece to body 10 and projects from the wall 21.

The hold-down device 12 has an annular wall 24 that surrounds the retaining cam 23 and ensures that the valve element 11 cannot be lifted from the retaining cam 23. Hold-down device 12 has several arms 25 that radiate in a star-shaped manner from an annular wall 24. On their radially outer ends, each arm 25 bears a hook 26 insertable, e.g., via a snap connection, into a groove 27 embodied or formed on body 10. In order to make snapping in easier, body 10 can have an inclined surface 28 in front of groove 27. When hold-down device 12 is pressed onto body 10, hooks 26 may be first placed against inclined surface 28 and can be spread apart by inclined surface 28 before snapping into groove 27. In order to remove hold-down device 12 from body 10, it is necessary only to slightly spread apart hooks 26 on arms 25. As soon as hooks 26 are released from groove 27, hold-down device 12 can be lifted from body 10 and valve element 11 can be replaced.

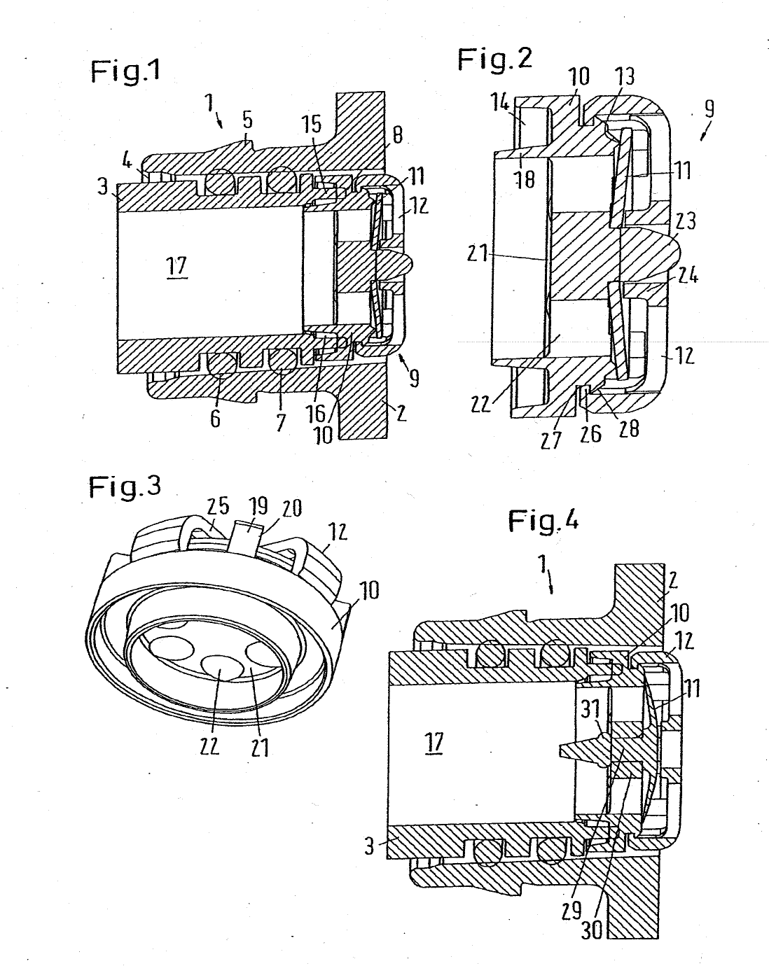

As can be seen in particular from FIG. 1, the free cross section of channel 17 is restricted by valve 9 virtually only through openings 22. Otherwise, the cross section of channel 17 is retained almost completely. Larger installations, which could restrict the cross section of channel 17, are not necessary.

FIG. 4 shows a modified embodiment of a push fit coupling 1, with which the same elements as in FIGS. 1 through 3 are provided with the same reference numbers.

The main difference here lies in valve element 11, which is embodied like a “mushroom.” Valve element 11 has a foot (or securing pin) 29, which is guided through a center piece 30 of body 10. A thickening 31 is provided on an end of foot 29 guided through center piece 30. Valve element 11, including foot 29, can be made of an elastically compressible material. The thickening can easily be pressed through center piece 30 now. Subsequently, thickening 31 expands again so that valve element 11 may be held in center piece 30 of body 10.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A push fit coupling for connecting two fluid lines, comprising:
a first element having a plug-in opening;
a second element insertable into the plug-in opening;
a retaining device for detachably holding the first and second elements together; and
a valve, insertable into the plug-in opening, is located on a front face of the second element.

2. The push fit coupling in accordance with claim 1, wherein the valve comprises a valve element and a body fixedly connected to the second element.

3. The push fit coupling in accordance with claim 2, wherein the body is welded to the second element.

4. The push fit coupling in accordance with claim 2, wherein the body further comprises at least two torque working surfaces.

5. The push fit coupling in accordance with claim 2, wherein the second element has a diameter enlargement in a region of the front face.

6. The push fit coupling in accordance with claim 5, wherein the second element has a reduced wall thickness in a region of the diameter enlargement.

7. The push fit coupling in accordance with claim 2, wherein the body has a peripheral groove into which the front face of the second element is connectable.

8. The push fit coupling in accordance with claim 7, wherein the front face is connectable to the peripheral groove through a snap connection.

9. The push fit coupling in accordance with claim 2, wherein the valve element is connected to the body via a slip joint.

10. The push fit coupling in accordance with claim 2, wherein the valve element comprises a valve plate.

11. The push fit coupling in accordance with claim 10, wherein the body includes a retaining cam onto which the valve plate is fitted.

12. The push fit coupling in accordance with claim 10, wherein the valve plate has a securing pin insertable into the body.

13. The push fit coupling in accordance with claim 10, wherein the valve plate is prestressed against a valve seat.

14. The push fit coupling in accordance with claim 13, wherein the valve seat is formed on the body.

15. The push fit coupling in accordance with claim 2, wherein a hold-down device for the valve element is snapped into the body.

16. The push fit coupling in accordance with claim 15, wherein the hold-down device comprises several arms arranged in a star-like manner and the body includes has projections arranged between the arms.

17. The push fit coupling in accordance with claim 1, wherein the second element is formed by a pipe, whereby the push fit coupling forms a pipe connection.

18. A method for connecting two elements, comprising:
positioning a valve on a front face of an element;
inserting the front face of the element into a plug-in opening of another element; and
detachably coupling the element and the another element together.

19. The method in accordance with claim 18, wherein the element and the another element comprise fluid lines to be connected.

20. The method in accordance with claim 18, further comprising restricting a flow of fluid directed toward the valve.
